(19) United States
(12) Patent Application Publication
(10) Pub. No.: US 2025/0302692 A1
(43) Pub. Date: Oct. 2, 2025

(54) VIBRATING MASSAGER

(71) Applicant: Dongguan XiQin Electrical Appliances Co.,Ltd, Dongguan City (CN)

(72) Inventor: Dashuai HU, Dongguan City (CN)

(21) Appl. No.: 18/657,705

(22) Filed: May 7, 2024

(30) Foreign Application Priority Data
Mar. 26, 2024 (CN) 202410348154.3

(51) Int. Cl. A61H 23/02

(52) U.S. Cl. CPC A61H 23/0263; A61H 2023/029; A61H 2201/0153

(57) ABSTRACT

A vibrating massager, comprising a vibrating massage section (100) and a handheld section (200). wherein the vibrating massage section (100) is connected to the handheld section (200), and the vibrating massage section (100) is provided with a massage head unit. The vibrating massage section (100) comprises a vibration generating system (300) and a flexible connecting body (400). The vibration generating system (300) is utilized to generate high-frequency vibrations and synchronously drive the vibrating massage section (100) for high-frequency vibrations. The flexible connecting body (400) is connected in between the vibrating massage section (100) and the handheld section (200), serving to flexibly fix the vibrating massage section (100) onto the handheld section (200). By utilizing the vibration generating system (300) and the flexible connecting body (400), the vibrating massage section (100) can perform high-frequency vibrations relative to the handheld section (200).

### BACKGROUND OF THE PRESENT INVENTION

### Field of Invention

The present invention relates to a massager, and more particularly to a massager that comprises a vibrating massage section and a handheld section. When in use, the vibrating massage section generates vibratory force. When the vibratory force generated by the vibrating massage section is applied to human body, the effect of vibrating massage on specific body parts can be achieved.

### Description of Related Arts

As human living quality continues to improve, people are now paying more and more attention to fitness exercises. Engaging in fitness activities can promote physical fitness and shape the body. After completing fitness exercises, proper muscle massage can help alleviate fatigue and relieve muscle soreness.

In order to meet the needs of people, manufacturers have developed some muscle massagers, with a typical example being a handheld massager as shown in FIG. 1. The handheld massager mainly includes a body (1) and a massage head (2), wherein the massage head (2) is assembled at the front end of the body (1). The main working principle is described as follows.

An electric motor and a driving structure are arranged in the body (1), and the massage head (2) is assembled at the front end of the driving structure. During operation, the electric motor drives the driving structure to perform a high-speed reciprocating motion. At the same time, the driving structure drives the massage head (2) to perform high-speed reciprocating motion. At this moment, when the massage head (2) applies on human body, the effect of massaging the specific muscles on human body can be achieved with the vibratory force of the massage head (2).

However, there are still many limitations to the operation of the above handheld massager, which are now described as follows.

Firstly, the structure of the driving structure of the above handheld massager is relatively complex, with a higher production costs and a higher failure rate.

Secondly, since the driving structure needs to perform high-speed reciprocating motion during operation, the movement of various components of the driving structure during operation leads to significant wear-and-tear, resulting in a limited overall product lifespan.

Thus, considered as the main limitations of the traditional technology.

### SUMMARY OF THE PRESENT INVENTION

The present invention provides a vibrating massager, comprising a vibrating massage section (100) and a handheld section (200), wherein said vibrating massage section (100) is connected to said handheld section (200), and said vibrating massage section (100) provided with a massage head unit, said vibrating massage section (100) comprises a vibration generating system (300) and a flexible connecting body (400), wherein said vibration generating system (300) is utilized to generate high-frequency vibrations and synchronously drive said vibrating massage section (100) for high-frequency vibrations, wherein said flexible connecting body (400) is connected in between said vibrating massage section (100) and said handheld section (200) is utilized to flexibly fix said vibrating massage section (100) onto said handheld section (200), by utilizing said vibration generating system (300) and said flexible connecting body (400), said vibrating massage section (100) can perform high-frequency vibrations relative to said handheld section (200).

The invention is advantageous in that it provides a vibrating massager, wherein the vibrating massage section (100) is directly and flexibly fixed onto the handheld section (200) through a flexible connecting body (400). During operation, the vibrating massage section (100) is driven to achieve high-frequency vibration by the vibration generating system (300), thereby providing vibrating massage to human body.

Another advantage of the invention is to provide a vibrating massager, wherein the vibrating massager is having a simple structure and lower manufacturing costs.

Another advantage of the invention is to provide a vibrating massager, wherein the vibrating massager is having a simple structure, a lower wear-and-tear rate between components and a longer product lifespan.

Another advantage of the invention is to provide a vibrating massager, wherein the vibratory direction of the vibrating massage section (100) is wide, thus, providing an effective vibrating massage.

Another advantage of the invention is to provide a vibrating massager, wherein the flexible connecting body (400) directly and flexibly fixes the vibrating massage section (100) onto the handheld section (200). The flexible connecting body (400) not only achieves the connection function but also achieves the purpose of vibration dampening. Meanwhile, the flexible connecting body (400) reduces the transmission of vibratory force from the vibrating massage section (100) to the handheld section (200), thereby improving the grip sensation of user on the handheld section (200) and enhancing user experience.

Another advantage of the invention is to provide a vibrating massager, wherein the internal motor of the vibrating massager operates in a simple manner with a stable structure, greatly extending the lifespan of the motor.

### BRIEF DESCRIPTION OF THE DRAWINGS

FIG. 1 is a schematic view of an existing technology muscle massager.

FIG. 2 is a perspective view of the structure of the present invention.

FIG. 3 is a perspective view of the vibration of the present invention.

FIG. 4 is a cross-sectional structural view of the present invention FIG.

FIG. 5 is a three-dimensional exploded view of the present invention.

FIG. 6 is a cross-sectional structural view of the motor of the present invention fixed in the motor frame in preferred embodiment 1.

FIG. 7 is a cross-sectional structural view of the motor of the present invention fixed in the motor frame in preferred embodiment 2.

FIG. 8 is a perspective view of the massage head connecting structure of the motor frame of the present invention.

FIG. 9 is a perspective view of the assembly disc of the motor frame of the present invention.

FIG. 10 is a perspective view of the working principle of the deformable body of the flexible connecting body of the present invention.

FIG. 11 is a cross-sectional structural view of the flexible connecting body of the present invention.

FIG. 12 is a three-dimensional structural view of the vibrating massage section and the flexible connecting body of present invention.

FIG. 13 is a three-dimensional exploded view of the present invention.

FIG. 14 is a exploded view of the present invention.

### DETAILED DESCRIPTION OF THE PREFERRED EMBODIMENT

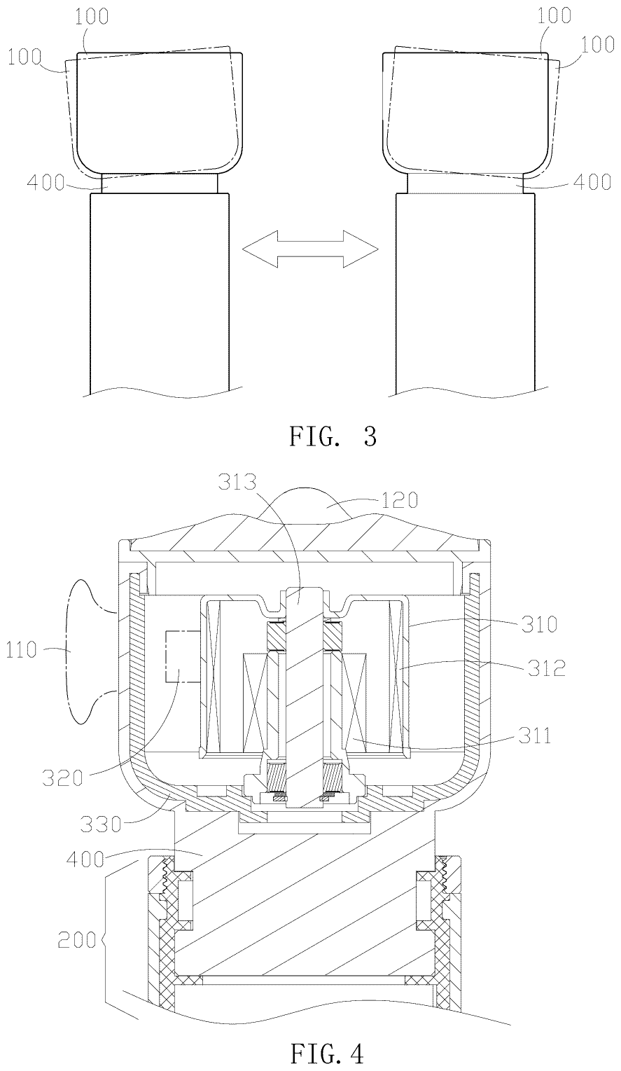

As shown in FIGS. 1 to 14, a vibrating massager, comprising a vibrating massage section (100) and a handheld section (200).

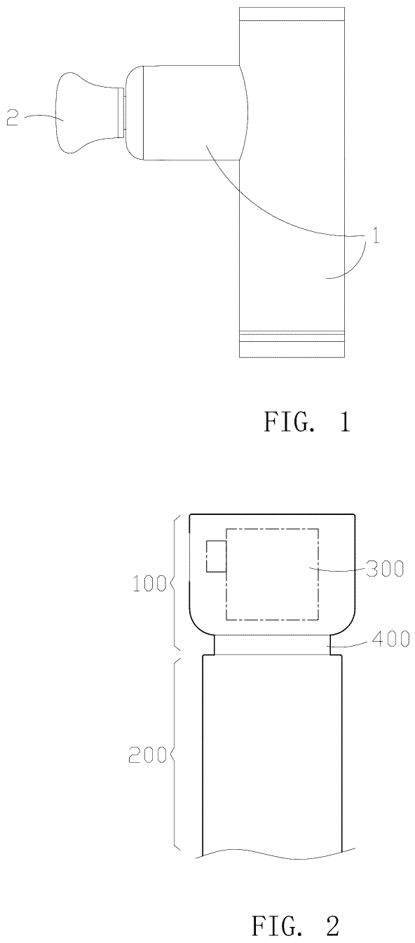

As shown in FIGS. 1 to 2, wherein the vibrating massage section (100) is connected to the handheld section (200).

When in use, the user grips the handheld section (200), and vibratiory force is generated by the vibrating massage section (100). When the vibratory force from the vibrating massage section (100) is applied to human body, the effect of vibrating massage on specific body parts can be achieved.

The vibrating massage section (100) is provided with a massage head unit.

In one embodiment, the massage head unit comprises a plurality of side massage heads (110) and a plurality of top massage heads (120).

Wherein the plurality of side massage heads (110) are arranged in a dispersed manner around the sides of the vibrating massage section (100), and the plurality of top massage heads (120) are arranged on the top of the vibrating massage section (100).

The vibrating massage section (100) comprises a vibration generating system (300) and a flexible connecting body (400).

Wherein the vibration generating system (300) is utilized to generate high-frequency vibration, and the vibrating massage section (100) is synchronously driven by the vibration generating system (300) to perform high-frequency vibration.

In one embodiment, the vibration generating system (300) is arranged within the vibrating massage section (100), wherein the flexible connecting body (400) is connected in between the vibrating massage section (100) and the handheld section (200). The flexible connecting body (400) is utilized to flexibly fix the vibrating massage section (100) to the handheld section (200).

By utilizing the vibration generating system (300) and the flexible connecting body (400), the vibrating massage section (100) can perform high-frequency vibration relative to the handheld section (200).

The main design concept of the present invention is that through directly and flexibly fixing the vibrating massage section (100) to the handheld section (200) using the flexible connecting body (400). During operation, the vibrating massage section (100) is driven by the vibration generating system (300) to produce high-frequency vibrations for the purpose of vibrating massage on human body. Products produced according to the design of the present invention have the following advantages.

Firstly, present invention is having a simple structure and lower manufacturing costs.

Secondly, present invention is having a simple structure, a lower wear-and-tear rate between components and a longer product lifespan.

Additionally, the vibratory direction of the vibrating massage section (100) of present invention is wide, providing an effective vibrating massage effect.

Additionally, through the flexible connecting body (400), the vibrating massage section (100) is directly and flexibly fixed onto the handheld section (200). The flexible connecting body (400) not only achieves the connection function but also achieves the purpose of vibration dampening.

The flexible connecting body (400) can reduce the transmission of vibratory force from the vibrating massage section (100) to the handheld section (200), thereby improving the grip sensation of user on the handheld section (200) and enhancing user experience.

Lastly, the product produced through the design concept of the present invention, the internal motor of the vibrating massager operates in a simple manner with a stable structure, greatly extending the lifespan of the motor.

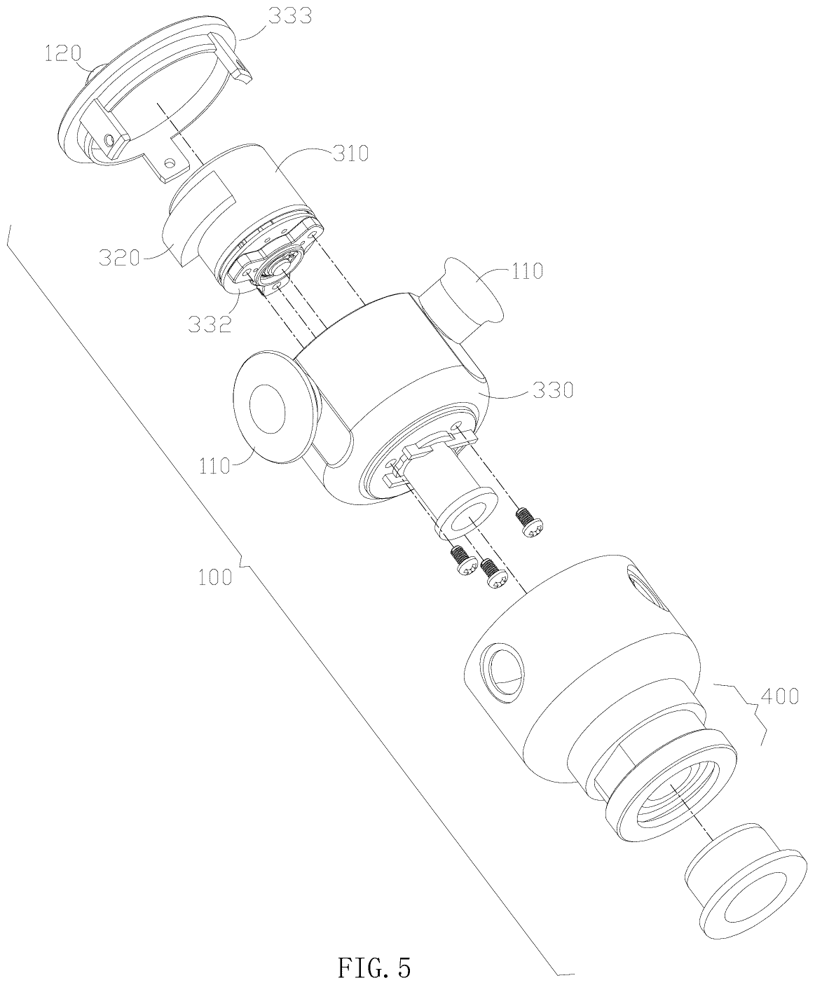

As shown in FIGS. 4 to 5, the vibration generating system (300) comprises a motor (310), an eccentric counterweight (320) and a motor frame (330).

Wherein the motor (310) is fixedly arranged in the motor frame (330). The motor (310) comprises a motor stator (311), a motor rotor (312) and a shaft (313). The eccentric counterweight (320) is fixedly arranged in the eccentric position of the motor rotor (312). The flexible connecting body (400) is connected in between the motor frame (330) and the handheld section (200).

When in use, the motor (310) is powered, and the motor rotor (312) rotates relative to the motor stator (311). By utilizing the eccentric counterweight (320), the motor frame (330) can perform high-frequency vibration. Thus, the vibration generating system (300) drives the vibrating massage section (100) to perform high-frequency vibration, achieving the effect of vibrating massage on human body.

During the process, firstly, the flexible connecting body (400) can be utilized to establish mechanical connection. Secondly, the flexible connecting body (400) can be utilized to isolate vibrations for the handheld section (200), thereby achieving the purpose of vibration dampening.

In one embodiment, the massage head unit is directly connected to the motor frame (330), generating a direct transmission of high-frequency vibrations.

In one embodiment, the motor (310) serves as the external rotor, and the rotor (312) serves as the rotating casing of the motor. The eccentric counterweight block (320) is fixedly arranged in the eccentric position of one side of the rotor (312).

The rotating casing of the motor is fixedly connected to a magnetic pole core, while the motor stator (311) is provided with a magnetic pole coil winding.

In order to stably fix the motor (310) in the motor frame (330) and ensure a stable structure, various preferred embodiment exist, described as follows.

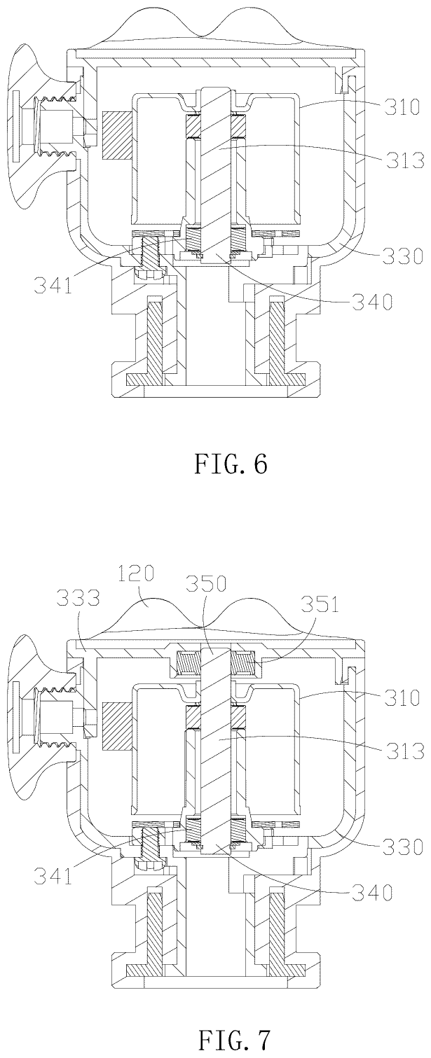

As shown in FIG. 6, the preferred embodiment one, the shaft (313) comprises a bottom extension shaft (340). wherein the bottom extension shaft (340) is extendedly arranged at the lower end of the shaft (313).

The bottom extension shaft (340) is positioned outside of the motor (310). The motor frame (330) is provided with a bottom bearing (341) at the bottom. The bottom extension shaft (340) is arranged in the bottom bearing (341).

By utilizing the bottom extension shaft (340) and the bottom bearing (341), the motor (310) is positioned in the motor frame (330).

As shown in FIG. 7, the preferred embodiment two, the shaft (313) comprises a bottom extension shaft (340) and a top extension shaft (350). wherein the bottom extension shaft (340) is extendedly arranged at the lower end of the shaft (313), while the top extension shaft (350) is extendedly arranged at the upper end of the shaft (313). Both the bottom extension shaft (340) and the top extension shaft (350) are positioned outside the motor (310).

The motor frame (330) is provided with a bottom bearing (341) at the bottom and a top bearing (351) at the top. wherein the bottom extension shaft (340) is arranged in the bottom bearing (341), while the top extension shaft (350) is arranged in the top bearing (351).

By utilizing the bottom extension shaft (340) and the bottom bearing (341), the bottom of the motor (310) is positioned in the motor frame (330). By utilizing the top extension shaft (350) and the top bearing (351), the top of the motor (310) is positioned in the motor frame (330).

Through the structure arrangement of the preferred embodiment two, the motor (310) can be stably fixed in the motor frame (330), ensuring a stable structure.

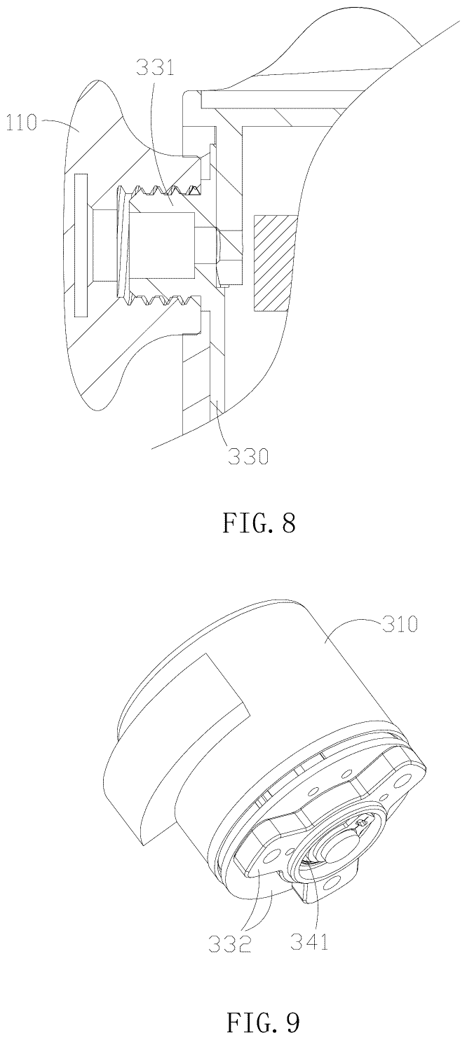

As shown in FIG. 8, in one embodiment, a plurality of massage head connecting structures (331) are disposed around the motor frame (330). The plurality of side massage heads (110) are correspondingly connected to the plurality of massage head connecting structures (331).

In actual practice, for ease of assembly, the massage head connecting structures (331) serve as externally threaded studs, and the side massage heads (110) are screwed onto the externally threaded studs.

As shown in FIG. 9, in one embodiment, an assembly disc (332) is connected to the motor frame (330) by screws. The bottom bearing (341) is arranged on the assembly disc (332).

In one embodiment, the motor frame (330) also comprises a frame top cover (333). wherein the frame top cover (333) is arranged on the top of the motor frame (330). The plurality of top massage heads (120) are positioned on the outer top of the frame top cover (333). The top bearing (351) is positioned on the inner bottom of the frame top cover (333).

In one embodiment, the flexible connecting body (400) is made of elastic or flexible materials, such as rubber, elastic silicone or other similar materials.

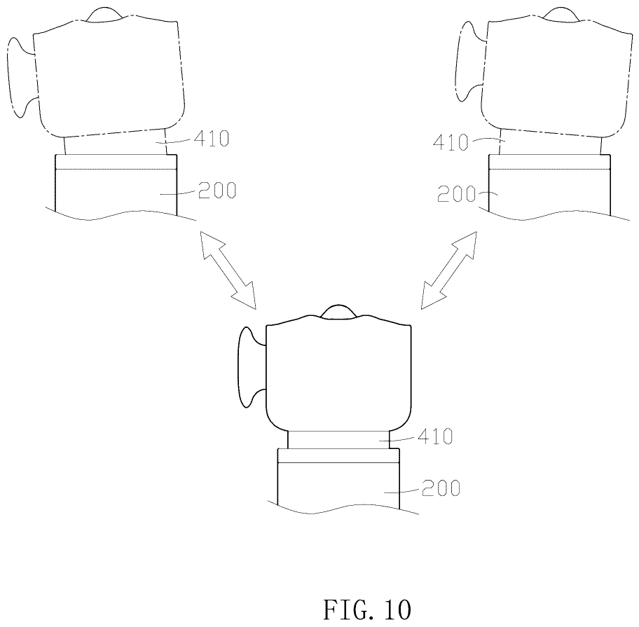

As shown in FIG. 10, the flexible connecting body (400), comprising a deformable body (410). The deformable body (410) is connected in between of the motor frame (330) of the vibration generating system (300) and the handheld section (200).

When the motor (310) operates, the deformable body (410) enables the motor frame (330) to perform high-frequency vibration on the handheld section (200).

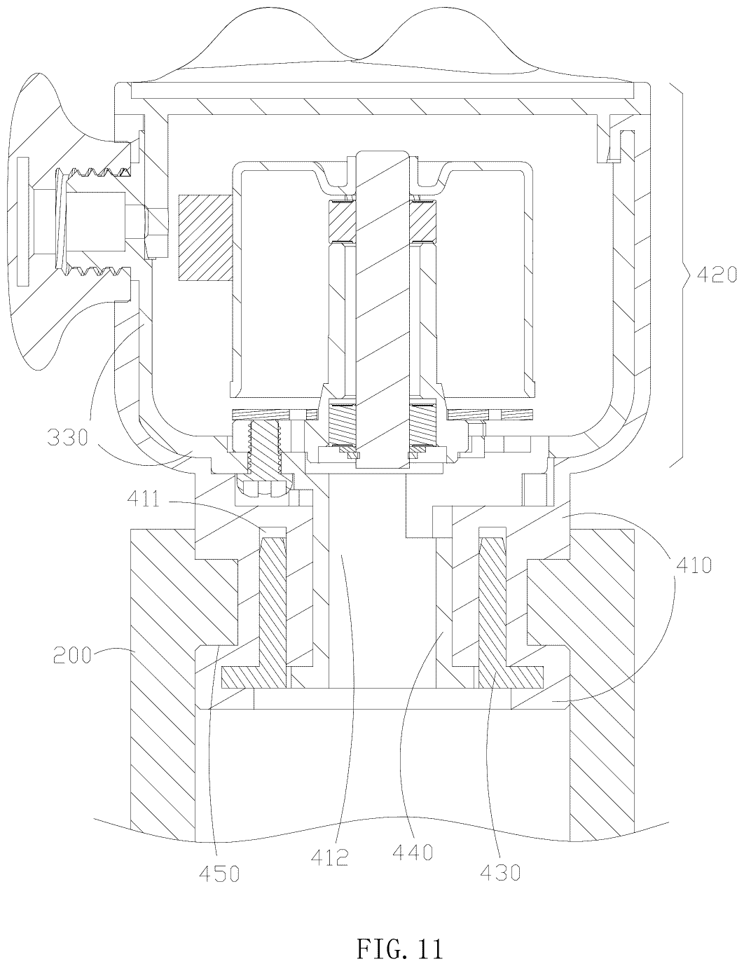

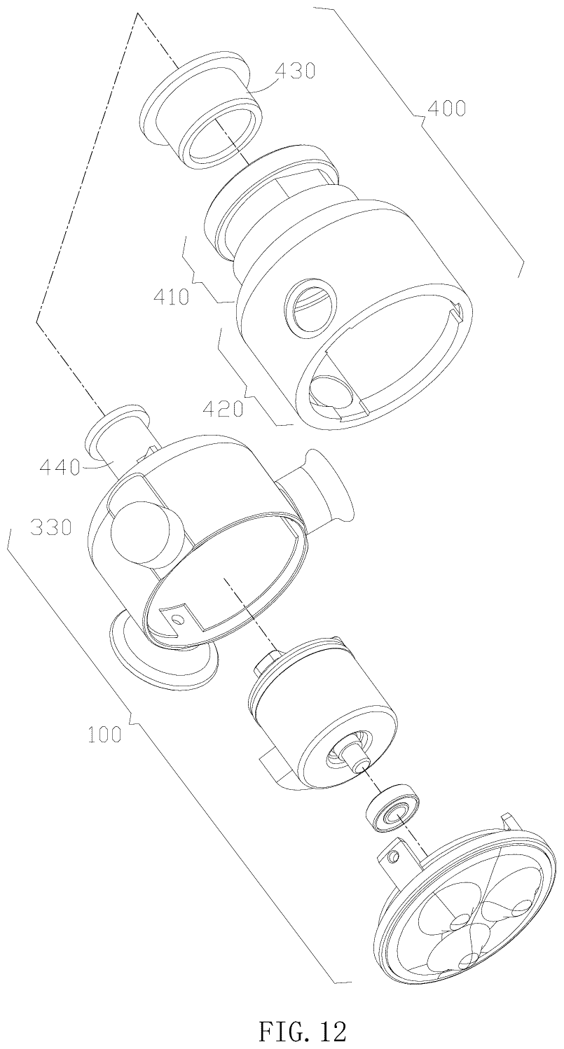

As shown in FIGS. 11 to 12, the flexible connecting body (400) also comprises a motor frame wrapping body (420). The motor frame wrapping body (420) wraps around the exterior of the motor frame (330). In one embodiment, the deformable body (410) and the motor frame wrapping body (420) are connected to form an integral unit, which can be processed and molded together.

The flexible connecting body (400) also comprises a rigid fixing frame (430). The rigid fixing frame (430) is made of hard materials, such as hard plastic, stainless steel or other similar materials. The rigid fixing frame (430) is embedded in the deformable body (410).

During high-frequency vibration of the vibration generating system (300), the rigid fixing frame (430) is utilized to limit the maximum deformation of the deformable body (410) and stabilize the deformable body (410).

The flexible connecting body (400) also includes a rigid anti-detachment frame (440). The rigid anti-detachment frame (440) is made of hard materials such as hard plastic, stainless steel or other similar materials. The rigid anti-detachment frame (440) is inserted into the deformable body (410), and the top of the rigid anti-detachment frame (440) is fixedly connected to the bottom of the motor frame (330).

During high-frequency vibration of the vibration generating system (300), the rigid anti-detachment frame (440) stabilizes the motor frame (330), preventing the vibration generating system (300) from detaching from the handheld section (200).

In one embodiment, the deformable body (410) is having a fixed groove (411) and an anti-detachment chamber (412). wherein the rigid fixing frame (430) is inserted into the fixed groove (411), while the rigid anti-detachment frame (440) is inserted into the anti-detachment chambers (412). In actual practice, both the rigid fixing frame (430) and the rigid anti-detachment frame (440) are tubular. The rigid fixing frame (430) and the rigid anti-detachment frame (440) form a concentric tube structure.

The flexible connecting body (400) also comprises a handle fixing groove (450). The handle fixing groove (450) is arranged on the outer surface of the deformable body (410). The top of the handheld section (200) is inserted into the handle fixing groove (450).

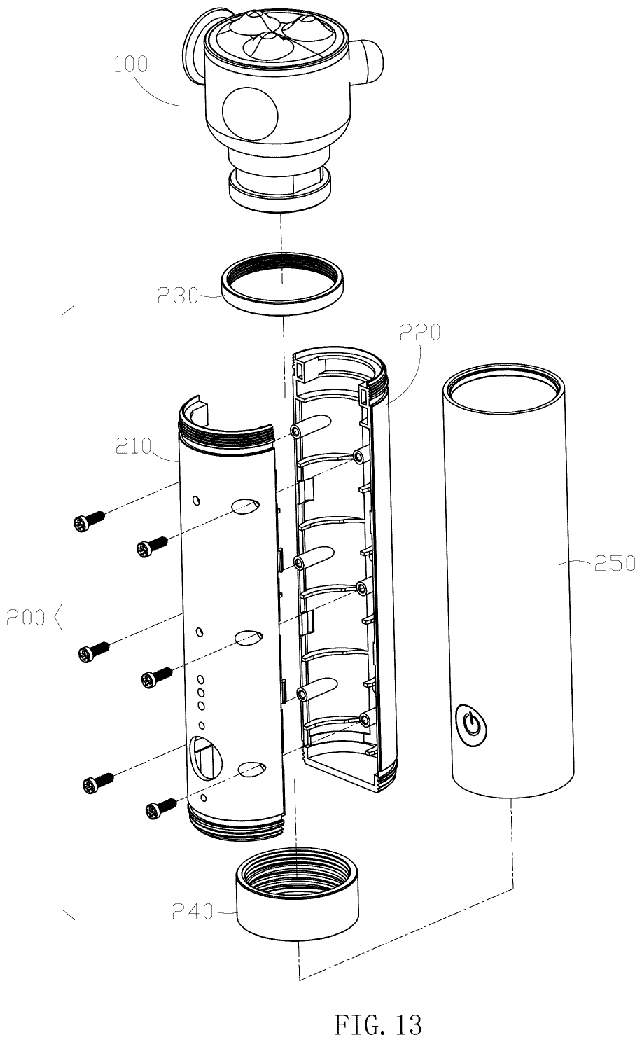

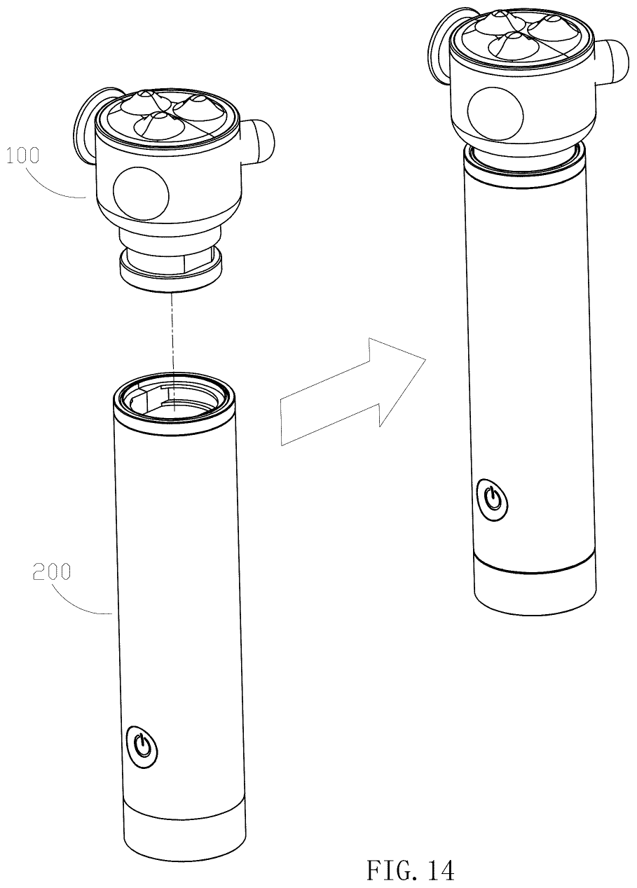

As shown in FIGS. 13 to 14, in one embodiment, the handheld section (200) comprises a first handle cover (210) and a second handle cover (220). The first handle cover (210) and the second handle cover (220) are joined together to form the handheld section (200).

The handheld section (200) also comprises an upper fixing ring (230) and a lower fixing ring (240). The upper fixing ring (230) and the lower fixing ring (240) are respectively threaded onto the upper ends and the lower ends of the handheld section (200).

In one embodiment, the top of the first handle cover (210) and the top of the second handle cover (220) are respectively inserted in the handle fixing groove (450) of the flexible connecting body (400), to complete the assembly and fixation of the flexible connecting body (400) and the handheld section (200).

In one embodiment, the handheld section (200) also comprises a handle protective sleeve (250). The handle protective sleeve (250) is fitted around the exterior of the first handle cover (210) and the second handle cover (220) to stabilize the structure of the handheld section (200), enhancing the grip sensation of the user.

What is claimed is:

1. A vibrating massager, comprising a vibrating massage section (100) and a handheld section (200),
wherein said vibrating massage section (100) is connected to said handheld section (200), and said vibrating massage section (100) provided with a massage head unit, said vibrating massage section (100) comprises a vibration generating system (300) and a flexible connecting body (400),
wherein said vibration generating system (300) is utilized to generate high-frequency vibrations and synchronously drive said vibrating massage section (100) for high-frequency vibrations,
wherein said flexible connecting body (400) is connected in between said vibrating massage section (100) and said handheld section (200) is utilized to flexibly fix said vibrating massage section (100) onto said handheld section (200),
by utilizing said vibration generating system (300) and said flexible connecting body (400), said vibrating massage section (100) can perform high-frequency vibrations relative to said handheld section (200).

2. The vibrating massager, as recited in claim 1, wherein said massage head unit comprises a plurality of side massage heads (110) and a plurality of top massage heads (120),
wherein said plurality of massage heads (110) are arranged in a dispersed manner around the sides of said vibrating massage section (100),
wherein said plurality of top massage heads (120) are positioned on the top of the vibrating massage section (100).

3. The vibrating massager, as recited in claim 1, wherein said vibration generation system (300) comprises a motor (310), an eccentric counterweight block (320), and a motor frame (330),
wherein said motor (310) is fixedly arranged in said motor frame (330), said motor (310) comprises a motor stator (311), a motor rotor (312), and a shaft (313), said eccentric counterweight block (320) is fixedly arranged in the eccentric position of said motor rotor (312), said flexible connecting body (400) is connected between said motor frame (330) and said handheld section (200).

4. The vibrating massager, as recited in claim 3, wherein said motor (310) serves as external rotor, and said rotor (312) serves as the rotating casing of the motor, said eccentric counterweight block (320) is fixedly arranged in the eccentric position of one side of said rotor (312).

5. The vibrating massager, as recited in claim 3, wherein said shaft (313) comprises a bottom extension shaft (340),
wherein the bottom extension shaft (340) is extendedly arranged at the lower end of the shaft (313), said bottom extension shaft (340) is positioned outside of said motor (310), said motor frame (330) is provided with a bottom bearing (341) at the bottom,
wherein said bottom extension shaft (340) is arranged in said bottom bearing (341),
by utilizing said bottom extension shaft (340) and said bottom bearing (341), said motor (310) is positioned in the motor frame (330).

6. The vibrating massager, as recited in claim 3, wherein the shaft (313) comprises a bottom extension shaft (340) and a top extension shaft (350),
wherein said bottom extension shaft (340) is extendedly arranged at the lower end of said shaft (313), while said top extension shaft (350) is extendedly arranged at the upper end of said shaft (313), both said bottom extension shaft (340) and said top extension shaft (350) are positioned outside said motor (310), said motor frame (330) is provided with a bottom bearing (341) at the bottom and a top bearing (351) at the top,
wherein said bottom extension shaft (340) is arranged in said bottom bearing (341), while said top extension shaft (350) is arranged in said top bearing (351),
by utilizing said bottom extension shaft (340) and said bottom bearing (341), the bottom of said motor (310) is positioned in said motor frame (330),
by utilizing said top extension shaft (350) and said top bearing (351), the top of the motor (310) is positioned in said motor frame (330).

7. The vibrating massager, as recited in claim 6, wherein an assembly disc (332) is connected to said motor frame (330) by screws, said bottom bearing (341) is arranged on the assembly disc (332).

8. The vibrating massager, as recited in claim 6, wherein said motor frame (330) also comprises a frame top cover (333),
wherein said frame top cover (333) is arranged on the top of said motor frame (330), said massage head units comprises a plurality of top massage heads (120),
wherein said plurality of top massage heads (120) are positioned on the outer top of said frame top cover (333), while said top bearing (351) is positioned on the inner bottom of the frame top cover (333).

9. The vibrating massager, as recited in claim 3, wherein a plurality of massage head connecting structures (331) are disposed around said motor frame (330), said plurality of side massage heads (110) are correspondingly connected to said plurality of massage head connecting structures (331).

10. The vibrating massager, as recited in claim 3, wherein said flexible connecting body (400) is made of elastic or flexible materials, said flexible connecting body (400) comprises a deformable body (410),
wherein said deformable body (410) is connected in between of said motor frame (330) of said vibration generating system (300) and said handheld section (200).

11. The vibrating massager, as recited in claim 10, wherein said flexible connecting body (400) also comprises a motor frame wrapping body (420),
wherein said motor frame wrapping body (420) wraps around the exterior of the motor frame (330).

12. The vibrating massager, as recited in claim 10, wherein said flexible connecting body (400) also comprises a rigid fixing frame (430),
wherein said rigid fixing frame (430) is made of hard materials, said rigid fixing frame (430) is embedded in said deformable body (410).

13. The vibrating massager, as recited in claim 12, wherein said flexible connecting body (400) also includes a rigid anti-detachment frame (440),
wherein said rigid anti-detachment frame (440) is made of hard materials, said rigid anti-detachment frame (440) is inserted into the deformable body (410), and the top of said rigid anti-detachment frame (440) is fixedly connected to the bottom of said motor frame (330).

14. The vibrating massager, as recited in claim 13, wherein said deformable body (410) is having a fixed groove (411) and an anti-detachment chamber (412),
wherein said rigid fixing frame (430) is inserted into said fixed groove (411), while said rigid anti-detachment frame (440) is inserted into said anti-detachment chambers (412).

15. The vibrating massager, as recited in claim 10, wherein said flexible connecting body (400) also comprises a handle fixing groove (450),
wherein said handle fixing groove (450) is arranged on the outer surface of said deformable body (410), while the top of said handheld section (200) is inserted into said handle fixing groove (450).

16. The vibrating massager, as recited in claim 3, wherein said handheld section (200) comprises a first handle cover (210) and a second handle cover (220),
wherein said first handle cover (210) and said second handle cover (220) are joined together to form said handheld section (200), said handheld section (200) also comprises an upper fixing ring (230) and a lower fixing ring (240),
wherein said upper fixing ring (230) and said lower fixing ring (240) are respectively threaded onto the upper ends and the lower ends of the handheld section (200).

17. The vibrating massager, as recited in claim 16, wherein said handheld section (200) also comprises a handle protective sleeve (250), said handle protective sleeve (250) is fitted around the exterior of said first handle cover (210) and said second handle cover (220).

18. A vibrating massager comprises a vibrating massage section (100) and a handheld section (200), wherein the vibrating massage section (100) is connected to the handheld section (200),
said vibrating massage section (100) is provided with a massaging head unit, said vibrating massage section (100) comprises a vibration generating system (300) and a flexible connecting body (400),
wherein said vibration generating system (300) is utilized to generate high-frequency vibrations and synchronously drive said vibrating massage section (100) to perform high-frequency vibrations,
wherein said flexible connecting body (400) is positioned in between said vibrating massage section (100) and said handheld section (200) to flexibly fix said vibrating massage section (100) onto said handheld section (200),
said vibration generating system (300) comprises a motor (310), an eccentric counterweight block (320), and a motor frame (330), wherein said motor (310) is fixedly arranged in said motor frame (330),
said motor (310) comprises a motor stator (311), a motor rotor (312), and a shaft (313), wherein said eccentric counterweight block (320) is fixedly arranged in an eccentric position on said motor rotor (312) of said motor (310), said flexible connecting body (400) is connected in between said motor frame (330) and said handheld section (200),
said flexible connecting body (400) is made of elastic or flexible materials, said flexible connecting body (400) comprises a deformable body (410), wherein said deformable body (410) connected in between said motor frame (330) of said vibration generating system (300) and said handheld section (200),
said flexible connecting body (400) also comprises a motor frame wrapping body (420), wherein said motor frame wrapping body (420) wraps around the exterior of said motor frame (330),
said flexible connecting body (400) comprises a rigid fixing frame (430), wherein said rigid fixing frame (430) is made of hard materials, said rigid fixing frame (430) is embedded within said deformable body (410),
said flexible connecting body (400) also comprises a rigid anti-detachment frame (440), wherein said rigid anti-detachment frame (440) is made of hard materials, said rigid anti-detachment frame (440) is inserted into said deformation body (410), the top of said rigid anti-detachment frame (440) is fixedly connected to the bottom of said motor frame (330),
said deformable body (410) is provided with a fixed groove (411) and an anti-detachment chamber (412), wherein said anti-detachment frame (440) is inserted into the anti-detachment chamber (412).
